(19) United States
(12) Patent Application Publication
(10) Pub. No.: US 2005/0137359 A1
(43) Pub. Date: Jun. 23, 2005

(54) Polyester molding composition

(75) Inventors: Parminder Agarwal, Evansville, IN (US); Peter H. Th.Vollenberg, Evansville, IN (US)

Correspondence Address: GEAM - O8CV - CPP;IP LEGAL, ONE PLASTICS AVENUE, PITTSFIELD, MA, 01201-3697, US

(73) Assignee: General Electric Company

(21) Appl. No.: 10/983,775

(22) Filed: Nov. 8, 2004

Related U.S. Application Data
(60) Provisional application No. 60/530,590, filed on Dec. 18, 2003.

(51) Int. Cl. C08L 67/02

(52) U.S. Cl. 525/437

(57) ABSTRACT

A clear thermoplastic resin blend comprises a low viscosity polyester cycloaliphatic resin derived from a cycloaliphatic diol or equivalent thereof and a cycloaliphatic dicarboxylic acid or equivalent thereof, a copolyesterether, an impact modifier and, optionally a polycarbonate wherein the resulting blend has a low flexural modulus with high Shore D hardness.

### CROSS REFERENCE TO RELATED APPLICATIONS

This application claims priority to U.S. Provisional Application Ser. No. 60/530590 filed on Dec. 18, 2003, which is incorporated herein by reference in its entirety.

### FIELD OF THE INVENTION

This invention relates to blends of polycarbonate and polyester resins.

### BACKGROUND OF THE INVENTION

U.S. Pat. No. 5,942,585 to Scott et al relates to blends of polycarbonates and polyesters where the polyester comprises a dicarboxylic acid component based on 1,4-cyclohexanedicarboxylic acid units and a glycol component comprising 2,2,4,4-tetramethyl-1,3-cyclobutanediol units. Miscible polycarbonate polyester blends are described in a Free Volume approach to the Mechanical Behaviour of Miscible Polycarbonate Blends, by A. J. Hill et al, J. Phys. Condens. Matter, 8, 3811-3827 (1996) and in Dynamic Mechanical and Dielectric Relaxation Study of Aliphatic Polyester Based Blends by Stack et al., J. M. Polym. Mater. Sci. Eng. (1993), 69, 4-5, Eastman Chemical Company, Kingsport, Tenn 37662. U.S. Pat. No. 4,879,355 to Light et al relates to a polymer blends comprising of a glycol copolyester having repeat units from 1,4-cyclohexanedimethanol, terephthalic acid and an alkylene glycol; a polycarbonate resin; and an aromatic polyester having repeat units from terephthalic acid, isophthalic acid and Bisphenol A. U.S. Pat. No. 4,786,692 to Allen et al. relates to a blend of an aromatic polycarbonate and a copolymer derived from a glycol portion comprising 1,4-cyclohexanedimethanol and ethylene glycol.

U.S. Pat. No. 5,399,661 to Borman et al relates to copolyester compositions which comprise the reaction product of at least one straight chain, branched, or cycloaliphatic C2-C10 alkane diol or a chemical equivalent and a mixture of at least two cycloaliphatic diacids. The diacid mixture comprises predominantly a trans isomer and at least one aromatic diacid. As set forth in column 5, lines 41 to 45, “The reaction is generally run with an excess of the diol component and in the presence of a suitable catalyst”. U.S. Pat. No. 5,486,562 to Borman et al additionally describes an impact strength modifier for compositions of the type set forth in the '661 patent.

U.S. Pat. No. 4,188,314 to Fox describes the addition of a polyester polymer derived from a cyclohexanedimethanol and a mixture of iso- and terephthalic acid to an aromatic carbonate polymer to enhance the solvent resistance as compared to a polycarbonate article.

Other references include patents U.S. Pat. Nos. 6,043,322; 6,037,424; 6,011,124; 6,005,059; 5,942,585; 5,194,523; and 5,017,659 and GB 1,559,230A.

Blends of polycarbonate and polyesters typically have attractive properties like toughness and chemical resistance. It is desirable to form blends of this type that retain these desirable properties but can additionally have desirable properties of low flex modulus and high hardness.

### SUMMARY OF THE INVENTION

According to an embodiment, polycarbonate polyester bends have very low flex modulus and high Shore D hardness. Typically, in most blends, these two properties are directly related. For example, when a blend has lower flex modulus, the hardness also reduces substantially and vice-versa. According to an embodiment, the polycarbonate polyester blends are easily processed by injection molding thereby enhancing their applicability for many applications. The properties, low flex modulus and high hardness translate into a polymer blend that has excellent flex fatigue resistance, tear resistance and hysteresis. In accordance with an embodiment, the material is exceptionally suited to golf ball shell types of applications where preventing the inner core from damage is important along with above-mentioned properties.

Properties of various blends are set forth in Table 2. Examples 1, 3, 8, 12 and 13 are examples of the invention and the remaining examples are comparative examples.

According to an embodiment, a thermoplastic resin blend comprising a low viscosity polyester cycloaliphatic resin derived from a cycloaliphatic diol or equivalent thereof and a cycloaliphatic dicarboxylic acid or equivalent thereof, a copolyesterether, an ABS resin and/or an impact modifier and, optionally a polycarbonate wherein the resulting blend has a low flexural modulus with high Shore D hardness. According to an embodiment, the resin blend has a flexural modulus from about 45 to about 120 kpsi and Shore D hardness from about 55 to about 72. According to an embodiment, the cycloaliphatic polyester resin has a weight average molecular weight of about 30,000 to about 150,000 atomic mass units (amu), with respect to polystyrene standards and the solvent is 5% hexafluoro iso-propyl alcohol in chloroform at room temperature. The weight average molecular weight of these polyesters is preferably from 65,000 to about 85,000 amu. According to an embodiment, the cycloaliphatic polyester is present in an amount from about 10 to about 40 percent by weight of the total resins. According to an embodiment, the copolyesterether is present in an amount from about 20 to about 55 percent by weight of the total resins. According to an embodiment, the impact modifier is present in an amount from about 20 to about 50 percent by weight of the total resins. According to an embodiment, the optional polycarbonate may comprise at least two different polycarbonate resins with each having a different molecular weight. If present, the polycarbonate is from about 5 to about 25 weight percent of the total resins.

It is desirable for low flex modulus blends to have good mechanical properties, which may be otherwise lost. As illustrated in Table 2 good mechanical properties are retained in Examples 1, 3, 8, 12 and 13.

### DETAILED DESCRIPTION OF THE INVENTION

For sake of clarity, the following Table 1 sets forth the meaning of the abbreviations used throughout the specification.

TABLE 1
Abbreviations

| Abbreviation | Name |
|---|---|
| PC | Polycarbonate |
| PCCE | Copolyesterether |
| PCCD | 1,4-cyclohexanedicarboxylic acid, polymer with |
| | 1,4-cyclohexanedimethanol (9CI Chemical Abstracts |
| | Index name); also |
| | Poly(1,4-cyclohexylenedimethylene 1,4- |
| | cyclohexanedicarboxylate) |
| ABS | Acrylonitrile butadiene styrene |
| CHDM | 1,4-cyclohexanedimethanol (trans/cis mixture) |
| t-DMCD | dimethyl trans-1,4-cyclohexanedicarboxylate |
| MV | Melt Viscosity |
| Tₘ | Melting Point |

A process for the preparation of molding composition comprises selecting a blend of the components PC (optional), PCCD, PCCE and an impact modifier for example. The impact modifier is added to enhance the desired mechanical properties.

The cycloaliphatic polyester resin has repeating units of the formula IA:

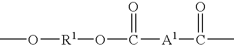

With reference to the previously set forth general formula, for R¹ is derived from 1,4-cyclohexane dimethanol or chemical equivalent; and A¹ is a cyclohexane ring derived from cyclohexanedicarboxylate or a chemical equivalent thereof. The favored PCCD has a cis/trans formula.

A preferred cycloaliphatic polyester is poly(cyclohexane-1,4-dimethylene cyclohexane-1,4-dicarboxylate) also referred to as poly(1,4-cyclohexane-dimethanol-1,4-cyclohexane-dicarboxylate) (PCCD) that has recurring units of formula IB:

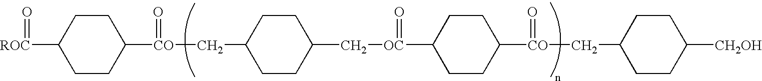

In formula IB, R is H or a lower alkyl.

The polyester polymerization reaction is generally run in the melt in the presence of a suitable catalyst such as a tetrakis(2-ethyl hexyl)titanate, in a suitable amount, typically about 50 to 200 ppm of titanium based upon the final product.

Preferred cycloaliphatic polyesters will have weight average molecular weights (determined by gel permeation chromatography using polystyrene standards) of about 30,000 to about 150,000 atomic mass units (amu), with about 60,000 to about 100,000 amu being preferred, and about 65,000 to about 95,000 amu being more preferred.

Also contemplated herein are the above polyesters with from about 1 to about 50 percent by weight, of units derived from polymeric aliphatic acids and/or polymeric aliphatic polyols to form copolyesters. The aliphatic polyols include glycols, such as poly(ethylene glycol) or poly(butylene glycol). Such polyesters can be made following the teachings of, for example, U.S. Pat. Nos. 2,465,319 and 3,047,539.

In the preferred formula IB:

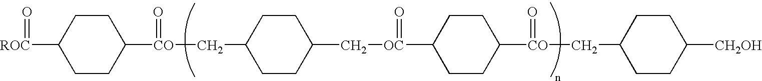

R is an alkyl from 1 to 6 carbon atoms or residual endgroups derived from either monomer, and n is greater than about 70. The polyester is derived from the transesterification reaction of a starting DMCD and a starting CHDM. The trans-cis ratio of repeating units derived from DMCD is preferably greater than about 8 to 1, and the trans-cis ratio of repeating units derived from CHDM is preferable greater than about 1 to 1. The weight average molecular weight of these polyesters is preferably from 65,000 to about 85,000 amu, a melting temperature preferably greater than 216° C., and an acid number preferably less than about 10, more preferably less than about 6 meq/kg.

The linear PCCD polyester can be prepared by the condensation reaction of CHDM and DMCD in the presence of a catalyst wherein the starting DMCD has a trans-cis ratio greater than the equilibrium trans-cis ratio. The resulting prepared PCCD polyester has a trans-cis ratio of repeating polymer units derived from the respective starting DMCD which has a trans-cis ratio substantially equal to the respective starting trans-cis ratio for enhancing the crystallinity of the resulting PCCD.

The starting DMCD typically has a trans-cis ratio greater than about 6 to 1, preferably greater than 9 to 1, and even more preferably greater than 19 to 1. In the resulting PCCD, it is preferable that less than about 10 percent of the starting trans DMCD, and more preferable that less than about 5 percent of the starting trans DMCD be converted to the cis isomer during the reaction of CHDM and DMCD to produce PCCD. The trnais:cis ratio of the CHDM is preferable greater than 1 to 1, and more preferably greater than about 2 to 1.

Preferably the amount of catalyst present is less than about 200 ppm. Typically, catalyst may be present in a range from about 20 to about 300 ppm. The most preferred materials are blends where the polyester has both cycloaliphatic diacid and cycloaliphatic diol components, specifically polycyclohexane dimethanol cyclohexyl dicarboxylate (PCCD).

Polyesterethers used in this invention can be prepared by conventional techniques such as described in the U.S. Pat. No. 4,349,469. One such preferred polyesterether is available commercially from Eastman Chemicals as ECDEL® resin. Other preferred polyesterethers include NEOSTAR® elastomers such as FN005, FN006 and FN007 available from Eastman Chemical Company. The dicarboxylic acid component of the polyesterether can consist essentially of 1,4-cyclohexanedicarboxylic acid having a trans isomer content of at least 70 percent, preferably at least 80 percent, and most preferably, at least 85 percent trans isomer content. 1,4-Cyclohexanedicarboxylic acid and 1,4-cyclohexanedimethanol can be made by known art and are commercially available. “Man-Made Fibers: Science and Technology,” Vol. III, edited by Mark, Atlas, and Cernia, published by Interscience Publishers describes preparation of 1,4-cyclohexanedicarboxylic acid and 1,4-cyclohexanedimethanol at page 85. The poly(oxytetramethylene) glycol component of the polyesterether is commercially available, and is prepared by well known techniques. The poly(oxytetramethylene) glycol has a molecular weight of between about 500 amu and about 1100 amu, preferably about 1000 amu (weight average). The polyesterether further may comprise up to about 1.5 mole percent, based on the acid or glycol component, of a polybasic acid or polyhydric alcohol branching agent having at least three COOH or OH functional groups and from 3 to 60 carbon atoms. Esters of many such acids or polyols may also be used. Suitable branching agents include trimellitic acid or anhydride, trimesic acid, trimethylol ethane, trimethylol propane, and trimer acid.

It should be understood that the total acid reactants should be 100 mole percent, and the total glycol reactants should be 100 mole percent. Although the acid reactant is said to “consist essentially of” 1,4-cyclohexanedicarboxylic acid, if the branching agent is a polybasic acid or anhydride, it will be calculated as part of the 100 mol percent acid. Likewise, the glycol reactant is said to “consist essentially of” 1,4-cyclohexanedimethanol and poly(oxytetramethylene)glycol, if the branching agent is a polyol, it will be calculated as part of the 100 mol percent glycol.

An ABS resin can be employed as well. These resins have units of acrylonitrile, butadiene, and styrene. When present it is from about 20 to about 50 wt % of the resin blend.

Preferred impact modifiers have polymer units of a low glass transition rubbery component in combination with polymeric units derived from vinyl aromatic compounds, acrylate compounds, alkylacrylate compounds or derivatives. Preferably the amount of impact modifier utilized is from about 5 to about 20 percent by weight based on the total weight of the resin molding composition.

To maintain ductility of a molded resin at temperatures on the order of minus ten degrees Centigrade, the preferred impact modifiers are core shell type impact modifiers having a rubbery core comprising a polymer derived from butadiene or n-butyl acrylate and a shell comprising a polymer derived from a vinylaromatic compound, a vinylcyanide compound, or an alkyl methacrylate compound, preferably the shell is derived from methacrylate alone or in combination with styrene. Especially preferred grafted polymers are the core-shell polymers of the type available from Rohm & Haas, for example Paraloid EXL3691. Also present in the first stage are cross-linking monomers and graft linking monomers. Examples of the cross-linking monomers include 1,3-butylene diacrylate, divinyl benzene and butylene dimethacrylate. Examples of graft linking monomers are allyl acrylate, allyl methacrylate and diallyl maleate.

Core-shell copolymers, method of making core-shell copolymers and the use of core-shell copolymers as impact modifiers in combination with polycarbonate are described in U.S. Pat. Nos. 3,864,428 and 4,264,487.

Suitable core-shell copolymers are those that include a rubbery ‘core” that has a glass transition temperature (“Tg”) below about minus 30° C., preferable below minus 40° C., and that comprises repeating units derived from one or more monoethylenically unsaturated monomers such as acrylate monomers, e.g. butyl acrylate, and conjugated diene monomers, e.g., butadiene and a rigid “shell” that has a Tg of greater than or equal to about 40° C. and that comprise repeating units derived from a monoethylenically unsaturated monomer, e.g., methyl methacrylate.

Another, preferred impact modifier which contains units derived from butadiene in combination with a vinyl aromatic compound comprises ABA triblock copolymers, especially those comprising styrene based blocks and butadiene or isoprene based blocks. As compared to the previously discussed core shell impact modifiers, the block copolymer impact modifiers lack low temperature ductility properties. The conjugated diene blocks may be partially or entirely hydrogenated, whereupon they may be represented as ethylene-propylene blocks or the like and have properties similar to those of olefin block copolymers. Examples of triblock copolymers of this type are polystyrene-polybutadiene-polystyrene (SBS), hydrogenated polystyrene-polybutadiene-polystyrene (SEBS), polystyrene-polyisoprene-polystyrene (SIS), poly(a-methylstyrene)-polybutadiene-poly(a-methylstyrene) and poly(a-methylstyrene)-polyisoprene-poly(a-methylstyrene).

Particularly preferred triblock copolymers are available commercially as Kraton D®, and KRATON G® from Shell. KRATON Polymers and compounds with an unsaturated rubber midblock constitute the KRATON D series (styrene-butadiene-styrene, SBS and styrene-isoprene-styrene, SIS) while those with a saturated midblock make up the KRATON G series (styrene-ethylene/butylene-styrene, SEBS and styrene-ethylene/propylene-styrene, SEPS). Both D- and G- series polymers are elastic and flexible. The KRATION G-series polymers are preferred for weather resistance due to increased oxidation resistance.

Polycarbonate resins useful in preparing the blends of the present invention are generally aromatic polycarbonate resins. The preferred polycarbonate comprises units of BPA, SBI bis phenol, aryl substituted bisphenols, cycloaliphatic bisphenols and mixtures thereof.

Typically these are prepared by reacting a dihydric phenol with a carbonate precursor, such as phosgene, a haloformate or a carbonate ester. Generally speaking, such carbonate polymers may be typified as possessing recurring structural units of the formula: —O—Ar—O—(CO)—, wherein Ar is a divalent aromatic radical of derived from dihydric phenol employed in the polymer producing reaction.

Preferably, the carbonate polymers used to provide the resinous mixtures of the invention have an intrinsic viscosity (as measured in methylene chloride at 25° C.) ranging from about 0.30 to about 1.00 dl/g.

The dihydric phenol which may be employed to provide such aromatic carbonate polymers are mononuclear or polynuclear aromatic compounds, containing as functional groups two hydroxy radicals, each of which is attached directly to a carbon atom of an aromatic nucleus. Typical dihydric phenols are: 2,2-bis(4-hydroxyphenyl)propane; hydroquinone; resorcinol; 2,2-bis(4-hydroxyphenyl)pentane; 2,4′-(dihydroxydiphenyl)methane; bis(2hydroxyphenyl)methane; bis(4-hydroxyphenyl)methane; bis(4-hydroxy-5-nitrophenyl)methane; 1,1-bis(4-hydroxyphenyl)ethane; 3,3-bis(4-hydroxyphenyl)pentane; 2,2-dihydroxydiphenyl; 2,6-dihydroxynaphthalene; bis(4-hydroxydiphenyl)sulfone; bis(3,5-diethyl-4-hydroxyphenyl)sulfone; 2,2-bis(3,5-dimethyl-4-hydroxyphenyl)propane; 2,4′-dihydroxydiphenyl sulfone; 5′-chloro-2,4′-dihydroxydiphenyl sulfone; bis-(4hydroxyphenyl)diphenyl sulfone; 4,4′-dihydroxydiphenyl ether; 4,4′-dihydroxy-3,3′-dichlorodiphenyl ether; 4,4-dihydroxy-2,5-dihydroxydiphenyl ether; and the like.

Other dihydric phenols which are also suitable for use in the preparation of the above polycarbonates are disclosed in U.S. Pat Nos. 2,999,835; 3,038,365; 3,334,154; and 4,131,575.

These aromatic polycarbonates can be manufactured by known processes, such as, for example and as mentioned above, by reacting a dihydric phenol with a carbonate precursor, such as phosgene, in accordance with methods set forth in the above-cited literature and in U.S. Pat. No. 4,123,436, or by transesterification processes such as are disclosed in U.S. Pat. No. 3,153,008, as well as other processes known to those skilled in the art.

It is also possible to employ two or more different dihydric phenols or a copolymer of a dihydric phenol with a glycol or with a hydroxy- or acid-terminated polyester or with a dibasic acid in the event a carbonate copolymer or interpolymer rather than a homopolymer is desired for use in the preparation of the polycarbonate mixtures of the invention. Branched polycarbonates can be useful, such as are described in U.S. Pat. No. 4,001,184. Also, there can be utilized blends of linear polycarbonate and a branched polycarbonate. Moreover, blends of any of the above materials may be employed in the practice of this invention to provide the aromatic polycarbonate.

The preferred aromatic carbonate for use in the practice in the present invention is a homopolymer, e.g., a homopolymer derived from 2,2-bis(4-hydroxyphenyl)propane (bisphenol-A), commercially available under the trade designation LEXAN® from General Electric Company.

The polymer blends includes about 20-55 weight percent of a copolyesterether. Typical copolyesterethers have an I.V. of about 0.8-1.5 dl/g and containing repeat units from a) a dicarboxylic acid component consisting essentially of 1,4-cyclohexanedicarboxylic acid having a trans isomer content of at least 70%, preferably at least 80%, b) a glycol component consisting essentially of 1) about 75-96 mol % of 1,4-cyclohexanedimethanol, preferably having a trans isomer content of at least 60%, and 2) about 25-4 mol % (about 15 to 50 wt %, based on the weight of the polyesterether), of poly(tetramethylene ether) glycol (PTMG) having a molecular weight of about 500 to 1100, and c) from 0 to about 1.5 mol %, based on the mole % of the acid or glycol component, of a branching agent having at least three functional groups consisting of COOH and/or OH and having from 3 to 60 carbon atoms.

Additionally, additives such as antioxidants, thermal stabilizers, mold release agents, antistatic agents, whitening agents, colorants, plasticizers, minerals such as talc, clay, mica, barite, wollastonite and other stabilizers including but not limited to UV stabilizers, such as benzotriazole, supplemental reinforcing fillers such as flaked or milled glass, and the like, flame retardants, pigments, additional resins or combinations thereof may be added to the compositions of the present invention. The different additives that can be incorporated in the compositions are commonly used and known to one skilled in the art. Illustrative descriptions of such additives may be found in R. Gachter and H. Muller, Plastics Additives Handbook, 4th edition, 1993.

Examples of thermal stabilizers include triphenyl phosphite, tris-(2,6-dimethylphenyl)phosphite, tris-(2,4-di-t-butyl-phenyl)phosphite, tris-(mixed mono-and di-nonylphenyl)phosphite, dimethylbenzene phosphonate and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin and epoxidized soybean oil. Examples of the antistatic agents include glycerol monostearate, sodium stearyl sulfonate, and sodium dodecylbenzenesulfonate.

A preferred class of stabilizers included in formulations is quenchers. Typically, such stabilizers are used at a level of 0.001-10 weight percent and preferably at a level of from 0.005-2 weight percent. The favored stabilizers include an effective amount of an acidic phosphate salt; an acid, alkyl, aryl or mixed phosphite having at least one acidic hydrogen; a Group IB or Group IIB metal phosphate salt; a phosphorus oxo acid, a metal acid pyrophosphate or a mixture thereof. The suitability of a particular compound for use as a stabilizer and the determination of how much is to be used as a stabilizer may be readily determined by preparing a mixture of the polyester resin component and the polycarbonate and determining the effect on melt viscosity, gas generation or color stability or the formation of interpolymer. The acidic phosphate salts include sodium dihydrogen phosphate, mono zinc phosphate, potassium hydrogen phosphate, calcium dihydrogen phosphate and the like. The phosphites may be of the formula V:

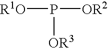

where R1, R2 and R3 are independently selected from the group consisting of hydrogen, alkyl and aryl with the proviso that at least one of R1, R2 and R3 is hydrogen.

The phosphate salts of a Group IB or Group IIB metal include zinc phosphate and the like. The phosphorus oxo acids include phosphorous acid, phosphoric acid, polyphosphoric acid or hypophosphorous acid.

The polyacid pyrophosphates may be of the formula VI:
MzxHyPnO3n+1
wherein M is a metal, x is a number ranging from 1 to 12 and y is a number ranging from 1 to 12, n is a number from 2 to 10, z is a number from 1 to 5 and the sum of (xz)+y is equal to n+2. The preferred M is an alkaline or alkaline earth metal.

The most preferred quenchers are oxo acids of phosphorus or acidic organo phosphorus compounds. Inorganic acidic phosphorus compounds may also be used as quenchers, however they may result in haze or loss of clarity. Most preferred quenchers are phosphoric acid, phosphorous acid or their partial esters.

Examples of mold releasing agents include pentaerythritol tetrastearate, stearyl stearate, beeswax, montan wax, and paraffin wax. Examples of other resins include but are not limited to polypropylene, polystyrene, polymethyl methacrylate, and polyphenylene oxide. Combinations of any of the foregoing additives may be used. Such additives may be mixed at a suitable time during the mixing of the components for forming the composition.

The polyesterethers preferably include a phenolic antioxidant, preferably, the phenolic antioxidant be hindered and relatively nonvolatile. Tetrakis[methylene(3,5-di-tert-butyl-4-hydroxyhydrocinnamate)methane], which is commercially available from Ciba-Geigy Chemical Company as Irganox 1010 antioxidant is preferred. Preferably, the antioxidant is used in an amount of from about 0.1 to about 1.0, based on the weight of copolyesterether.

The production of the compositions may utilize any of the blending operations known for the blending of thermoplastics, for example blending in a kneading machine such as a Banbury mixer or an extruder. The sequence of addition is not critical but all components should be thoroughly blended.

To prepare the resin composition, the components may be mixed by any known methods. Typically, there are two distinct mixing steps: a premixing step and a melt mixing step. In the premixing step, the dry ingredients are mixed together. The premixing step is typically performed using a tumbler mixer or ribbon blender. However, if desired, the premix may be manufactured using a high shear mixer such as a Henschel mixer or similar high intensity device. The premixing step is typically followed by a melt mixing step in which the premix is melted and mixed again as a melt. Alternatively, the premixing step may be omitted, and raw materials may be added directly into the feed section of a melt mixing device, preferably via multiple feeding systems. In the melt mixing step, the ingredients are typically melt kneaded in a single screw or twin screw extruder, a Banbury mixer, a two roll mill, or similar device.

The composition may be shaped into a final article by various techniques known in the art such as injection molding, compression molding, extrusion, gas assist blow molding, or vacuum forming.

### EXAMPLES

In the following examples and throughout the specifications and claims, all amounts are weight percents based on the total weight of the resins in the composition unless otherwise indicated. All ingredients were mixed in a ribbon blender and extruded on a Wemer-Pleiderer twin screw extruder at 260° C. to form pellets. The pellets were then fed into an injection moulding machine to mould discs-test bars. The test procedures are as follows:

From the granulate, the melt volume rate (MVR) was measured according ISO 1133 (265° C./2.16kg, unless otherwise stated) in units of cm³/10 min.

Heat distortion temperature, HDT are measured on 3.2 mm thick, 126 mm long flex bars according ASTM D648.

Tensile Properties: The testing procedure follows the ATSM D638 standard. The test is carried out on a Zwick 1474 (+HASY). This machine is equipped with an automatic handling system. Tensile bars of type I ASTM with the following dimensions were used: width of 13 mm and thickness of 3.2 mm.

Notched Izod: This test procedure is based on the ASTM D256 method. In this case, using Izod Method E, the notched impact strength is obtained by testing an notched specimen. The results of the test is reported in terms of energy absorbed per unit of specimen width, and expressed in foot times pounds per inch (Ft.Lbs./In.). Typically the final test result is calculated as the average of test results of five test bars.

Dynatup impact test: This test procedure is based on the ASTM D3763 method. This procedure provides information on how a material behaves under multiaxial deformation conditions. The deformation applied is a high-speed puncture. An example of a supplier of this type of testing equipment is Dynatup. Reported as the test result is the, so-called total energy absorbed (TE), which is expressed in foot times pounds (Ft.Lbs.). The final test result is calculated as the average of the test results of typically ten test plaques.

Melt viscosity: This test procedure is based on the ASTM D1238 method. The equipment used is an extrusion plastometer equipped with an automatic timer. A typical example of this equipment would be the Tinius Olson MP 987. Before testing, the samples are dried for one hour at 150° C. The testing conditions are a melt temperature of 266° C., a total load of 5,000 gram, an orifice diameter of 0.0825 inch, and a dwell time of 5 minutes. The test result is expressed in the unit Poise.

Flexural Modulus: This test procedure is based on the ASTM D790 method. Typical test bars have the following dimensions: 13 mm times 126 mm and a thickness of 3.2 mm. The final test result is calculated as the average of test results of five test bars. The test involves a three-point loading system utilizing center loading on a simply supported beam. The test measures the ratio of the extent of deformation produced in a material subjected to certain flexing force. Low flex modulus number implies the material has relatively higher deformation when the flexing force is applied.

Instron and Zwick are typical examples of manufacturers of instruments designed to perform this type of test. The flexural modulus is the ratio, within the elastic limit, of stress to corresponding strain and is expressed in pounds per square inch (psi).

Shore D hardness is measured by D digital durometer from Zwick, USA. The durometer test is carried out according to ASTM D2240 procedure. Shore D Hardness measures the ability of a material to resist penetration of the Shore D probe. Higher hardness number implies the material is more resistant to penetration.

TABLE 2
Properties of various blends. Examples 1, 3, 8, 12 and 13 are
examples of the invention and the remaining examples are comparative examples.

| Formulations [%] | −1 | −2 | −3 | −4 | −5 | −6 | −7 |
|---|---|---|---|---|---|---|---|
| PC high flow | 5.0 | 15.0 | 6.3 | 7.9 | 15.0 | 15.0 | 15.0 |
| PC 100 grade | 5.0 | 15.0 | 6.3 | 7.9 | 15.0 | 15.0 | 15.0 |
| PCCD, 2K | 0.0 | 0.0 | 0.0 | 0.0 | 0.0 | 0.0 | 0.0 |
| PCCD, 4k poise | 30.0 | 12.5 | 12.5 | 30.0 | 10.0 | 30.0 | 30.0 |
| PCCE (Eodel) | 30.0 | 12.5 | 30.0 | 15.8 | 30.0 | 10.0 | 0.0 |
| SAN Polymer | 0.0 | 0.0 | 0.0 | 0.0 | 0.0 | 0.0 | 0.0 |
| ABS Resin | 29.5 | 44.5 | 44.5 | 37.8 | 29.5 | 29.5 | 39.5 |
| Phosphoric Add | 0.075 | 0.075 | 0.075 | 0.075 | 0.075 | 0.075 | 0.075 |
| pre-diluated | | | | | | | |
| to 10% | | | | | | | |
| Pentaerythritol | 0.300 | 0.300 | 0.300 | 0.300 | 0.300 | 0.300 | 0.300 |
| tetrastearate | | | | | | | |
| PEP-Q | 0.150 | 0.150 | 0.150 | 0.150 | 0.150 | 0.150 | 0.150 |
| Total | 100.0 | 100.0 | 100.0 | 100.0 | 100.0 | 100.0 | 100.0 |
| Shore D Hardness | 68 | 71 | 66 | 70 | 71 | 73 | 72 |
| MVR(cm3/10 min) | 20.07 | 3.68 | 7.90 | 9.50 | 17.70 | 11.70 | 5.30 |
| Flexural Modulus(kpsi) | 111 | 204 | 106 | 171 | 193 | 216 | 206 |
| Secant Mod. | 104 | 199 | 99.9 | 168 | 189 | 210 | 201 |
| @2% strain(kpsi) | | | | | | | |
| Flexural Strength(kpsi) | 3.77 | 6.74 | 3.52 | 5.78 | 6.55 | 7.53 | 7.16 |
| HDT (° C.) | 41.5 | 70.4 | 44.6 | 52.7 | 53.1 | 69.2 | 82.8 |
| Izoct Ductility(%) | 100 | 100 | 100 | 100 | 100 | 100 | 100 |
| Impact Strength(lbf/in) | 14.499 | 12.632 | 13.058 | 13.795 | 14.468 | 15.093 | 13.259 |
| MAIMPACT- | 100 | 100 | 100 | 100 | 100 | 100 | 100 |
| Ductility(%) | | | | | | | |
| Energy to | 24.5 | 27.5 | 20.9 | 25.8 | 28.3 | 32.8 | 31.9 |
| Max Load(ft-lbf) | | | | | | | |
| Total Energy(ft-lbf) | 35.7 | 31.5 | 32.5 | 34.9 | 37.4 | 37.9 | 36.8 |
| Tensile Modulus(PSI) | 95100 | 181000 | 87500 | 158000 | 178000 | 192000 | 182000 |
| Tensile | 3240 | 4640 | 2880 | 4190 | 4720 | 5230 | 4860 |
| Stress@Yield(PSI) | | | | | | | |
| Tensile | 3090 | 4330 | 2820 | 4310 | 4710 | 5480 | 4760 |
| Stress@Break(PSI) | | | | | | | |
| Ten. | 5.10 | 4.12 | 5.24 | 4.10 | 4.04 | 4.30 | 4.40 |
| Elongation@Yield(%) | | | | | | | |
| Ten | 213.40 | 143.58 | 180.96 | 210.84 | 182.76 | 181.10 | 166.34 |
| Elongation@Break(%) | | | | | | | |

| Formulations [%] | −8 | −9 | −10 | −11 | −12 | −13 |
|---|---|---|---|---|---|---|
| PC high flow | 0.0 | 12.5 | 15.0 | 0.0 | 0.0 | 5.0 |
| PC 100 grade | 0.0 | 12.5 | 15.0 | 0.0 | 0.0 | 5.0 |
| PCCD, 2K | 0.0 | 0.0 | 0.0 | 0.0 | 19.1 | 30.0 |
| PCCD, 4k poise | 30.0 | 30.0 | 0.0 | 12.5 | 0.0 | 0.0 |
| PCCE (Eodel) | 25.0 | 0.0 | 25.0 | 12.5 | 49.0 | 30.0 |
| SAN Polymer | 0.0 | 0.0 | 0.0 | 30.0 | 0.0 | 0.0 |
| ABS Resin | 44.5 | 44.5 | 44.5 | 44.5 | 31.5 | 29.0 |
| Phosphoric Add | 0.075 | 0.075 | 0.075 | 0.075 | 0.000 | 0.500 |
| pre-diluated | | | | | | |
| to 10% | | | | | | |
| Pentaerythritol | 0.300 | 0.300 | 0.300 | 0.300 | 0.300 | 0.300 |
| tetrastearate | | | | | | |
| PEP-Q | 0.150 | 0.150 | 0.150 | 0.150 | 0.150 | 0.150 |
| Total | 100.0 | 100.0 | 100.0 | 100.0 | 100.0 | 100.0 |
| Shore D Hardness | 63 | 70 | 70 | 70 | 58 | 68 |
| MVR(cm3/10 min) | 8.30 | 3.10 | 4.50 | 8.50 | 27.6 | 22.0 |
| Flexural Modulus(kpsi) | 88.6 | 193 | 195 | 197 | 52 | 110 |
| Secant Mod. | 83.8 | 188 | 191 | 191 | 63.6 | 90.8 |
| @2% strain(kpsi) | | | | | | |
| Flexural Strength(kpsi) | 3.08 | 6.61 | 6.32 | 6.13 | 2.63 | 3.45 |
| HDT (° C.) | 43.9 | 78.7 | 58.6 | 74.0 | 40 | 41.5 |
| Izoct Ductility(%) | 100 | 100 | 100 | 100 | 100 | 100 |
| Impact Strength(lbf/in) | 13.243 | 13.293 | 12.782 | 12.423 | 14.7 | 14.6 |
| MAIMPACT- | 100 | 100 | 100 | 100 | 100 | 100 |
| Ductility(%) | | | | | | |
| Energy to | 15.3 | 26.6 | 26.0 | 18.9 | 18.2 | 27.5 |
| Max Load(ft-lbf) | | | | | | |
| Total Energy(ft-lbf) | 29.6 | 31.1 | 32.2 | 33.9 | 27.8 | 32.7 |
| Tensile Modulus(PSI) | 54000 | 170000 | 178000 | 183000 | 20800 | 86900 |
| Tensile | 2560 | 4500 | 4460 | 4450 | 2200 | 3040 |
| Stress@Yield(PSI) | | | | | | |
| Tensile | 3310 | 4690 | 3710 | 3390 | 2730 | 3300 |
| Stress@Break(PSI) | | | | | | |
| Ten. | 6.24 | 4.48 | 4.06 | 4.12 | 16.16 | 5.3 |
| Elongation@Yield(%) | | | | | | |
| Ten | 266.02 | 166.10 | 154.40 | 211.16 | 234 | 208 |
| Elongation@Break(%) | | | | | | |

1. A thermoplastic resin blend comprises of a polyester cycloaliphatic resin derived from a cycloaliphatic dialkanol or equivalent thereof and a cycloaliphatic dicarboxylic acid or equivalent thereof, a copolyesterether, ABS resin and/or an impact modifier and, optionally a polycarbonate wherein the resulting blend has a low flexural modulus with high Shore D hardness.

2. A thermoplastic resin blend according to claim 1 wherein said resin has a flexural modulus from about 45 kpsi to about 120 kpsi and a Shore hardness from about 55 to about 72.

3. A thermoplastic resin blend according to claim 1 wherein cycloaliphatic polyester resin that has a weight average molecular weight of from 65,000 to about 85,000 amu.

4. A thermoplastic resin blend according to claim 1 wherein cycloaliphatic polyester is present in an amount from about 10 to about 40 percent by weight.

5. A thermoplastic resin blend according to claim 1 wherein copolyesterether is present in an amount from about 20 to about 55 percent by weight.

6. A thermoplastic resin blend according to claim 1 wherein the ABS resin is present in an amount from about 20 to about 50 percent by weight.

7. A thermoplastic resin blend according to claim 1 wherein the impact modifier is present in an amount from about 20 to about 50 percent by weight.

8. A thermoplastic resin blend according to claim 1 wherein the optional polycarbonate may comprise at least two different polycarbonate resins with each having a different molecular weight.

9. A shaped article molded from the blend of claim 1.

10. A shaped article molded from the blend of claim 2.
